(19) United States
(12) Patent Application Publication
(10) Pub. No.: US 2024/0198721 A1
(43) Pub. Date: Jun. 20, 2024

(54) EMBOSSED WOOD PRODUCTS

(71) Applicant: CanWel Building Materials Ltd., Vancouver (CA)

(72) Inventors: Jack Wang, Heze City (CN); Thomas Boursier, Vancouver (CA)

(73) Assignee: CanWel Building Materials Ltd., Vancouver, BC (CA)

(21) Appl. No.: 18/068,664

(22) Filed: Dec. 20, 2022

(51) Int. Cl. B44F 9/02; B27N 7/00; B44C 1/24

(52) U.S. Cl. CPC B44F 9/02; B27N 7/00; B44C 1/24

(57) ABSTRACT

This disclosure is directed to a method for embossing Paulownia wood using an embossing machine. The method involves passing the wood piece past a first embossing drum that applies a pattern embedded in the cylindrical surface of the drum into the wood piece by the drum applying pressure against the first flat surface of the wood piece.

### FIELD

This disclosure relates to embossing patterns on Paulownia wood products. In more particular, it relates to embossing a simulated wood grain pattern to Paulownia wood trim products.

### BACKGROUND

Wood products are used for a variety of purposes, such as for furniture, structural and ornamental locations on vehicles (air, water, land), and on structures. In some situations, having a pleasing finish to the wood is desirable. Natural surfaces of wood products may include visible grain features.

With more wood products being highly processed or engineered, such as laminating smaller pieces together, gluing smaller pieces together, particle board, oriented strand board (OSB) and various fibreboard (such as medium-density fibreboard (MDF) and high-density fibreboard (HDF)). In some cases, the engineered wood may be prepared to resemble natural wood on one or more surfaces.

It is desirable to prepare wood products with the appearance of natural wood surfaces.

### BRIEF DESCRIPTION OF THE DRAWINGS

In drawings which illustrate by way of example only a preferred embodiment of the disclosure,

FIG. 1A is a perspective view of an unembossed piece of wood.

FIG. 1B is a top view of a piece of wood embossed on one side.

FIG. 2 is a perspective view of an embossing machine with two drums.

FIG. 3 is a perspective view of a home with embossed wood pieces having been applied as column, batten, fascia, door, window and corner trim.

### DETAILED DESCRIPTION

In an embodiment, wood from the species of tree referred to as Paulownia is used for a wood product. The Paulownia tree is a type of hardwood tree grown extensively in China.

The Paulownia tree can grow to maturity in less than 10 years. When harvested, the Paulownia wood is generally strong and lightweight. It generally has a strength to weight ratio exceeding that of balsa wood. Paulownia may be more resistant to rot and decay than other woods as well as resistant to warps, cracks and splits.

The Paulownia wood may be cut and planed into boards of suitable size common in the industry. For example, planks may be prepared that are 1 inch (2.5 cm) thick, various widths (such as between 3 inches/8 cm and 12 inches/30 cm) and lengths (such as 12 feet/3.7 m).

In some cases, smaller pieces of Paulownia wood may be combined to prepare boards of a suitable size. The smaller pieces may be glued, such as with a finger joint, together to form the boards. Finger joints may be used to joint smaller pieces end-to-end. Lamination may be used to join the smaller pieces. For example, lamination may be used to join smaller pieces side-by-side. An adhesive, such as Aquence SL 3184™ from Henkel Adhesive Technology may be used to joint smaller pieces.

The joining of smaller pieces may be done if smaller pieces are more readily available or harvested, or are less costly to obtain. For example, trees may be harvested and the wood milled to assembled together to form wood pieces of 4 foot/1.2 m lengths which are then joined together to form planks of 12 feet/3.7 m.

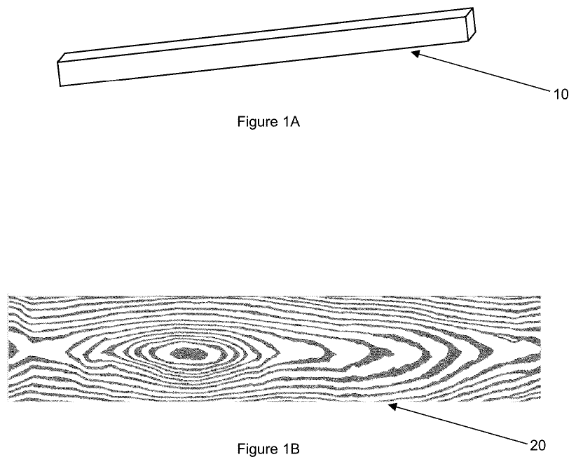

With reference to FIG. 1A, the surfaces of the wood 10 may be finished such as by planer and/or jointer to create a piece that has a surfaces at right angles and a smooth surface.

In an embodiment, one or more of the surfaces of the wood may be embossed with a pattern. The pattern may consist of higher and lower portions, such as ridges and valleys forming a pattern in relief. The pattern may be any pattern, such as a geometric pattern, a tessellation or other pattern. The pattern may repeat and be designed so that it repeats without apparent interruption.

With reference to FIG. 1B, the wood piece 20 may be embossed with a pattern that resembles or simulates a natural grain pattern. The grain pattern may include ridges and valleys representing the growth rings of wood, such as fir or pine, including higher density rings proximate branches. For example, portions corresponding to darker portions of the wood grain may embossed deeper into the wood, while lighter portions are embossed less deep. The difference in depth may be preferably be about 0.5 mm.

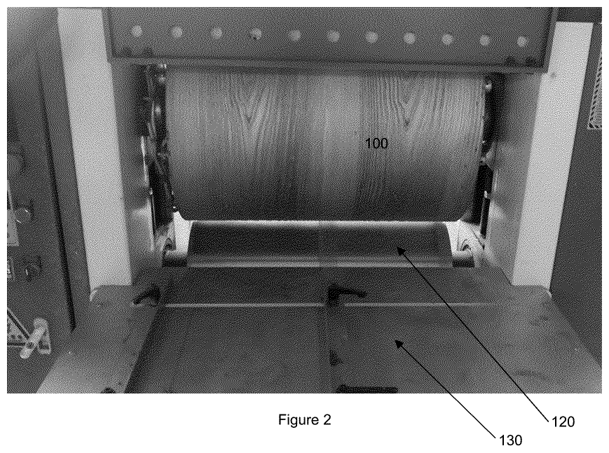

With reference to FIG. 2, the pattern may be embossed on the wood by creating a drum 100 with a negative version of the pattern on the circumference of the drum. The pattern may be applied around the full circumference of the drum. The repeatability of the pattern may be an even multiple of the circumference of the drum. For example, the pattern may repeat once or twice around the surface of the drum without an apparent interruption in the pattern.

The wood piece may be slid past the drum with pressure applied by the drum against the wood piece as the drum rolls along the length of the wood. The pattern on the drum is then transferred to the surface of the wood by deforming the wood. Raised portions on the drum deform the wood by a greater amount forming deeper valleys in the wood.

An embossing machine may involve a drum on one side to emboss only a single surface of the wood, or a pair of drums with the wood passing between the drums. If two drums are used, the second drum 120 may also have an embossing pattern so that two sides of the wood may be embossed at the same time. Alternatively, the second drum may be smooth so the reverse side of the wood is not embossed but the second drum may assist with drawing the wood past the first drum. In a further embodiment, the wood may be embossed on additional surfaces, such as the sides of the wood by having one or more additional drums or re-applying the wood through the same drums more than once in alternative orientations.

The rotation of the drum may be powered, such as by an electric motor, to draw the wood piece past the drum. If a single drum is used, a hard surface, such as a steel table, may support the wood and provide the counter pressure against the drum so that the pattern is applied to the wood. Entrance table and exit table 130, may support the wood piece as it enters and exits from the embossing drum.

In an embodiment, the drum may have a diameter of 500 mm and a width of 610 mm. The surface of the drum may be made from a hard material to withstand repeated the embossing, such as 1045 carbon steel. The surface of the drum may be chrome plated to further protect the surface. The pattern may be milled into the drum, such as with a depth of 0.3 mm to 1 mm. The depth of the pattern on the drum may be deeper than the desired depth on the finished wood product as wood may partially spring back after being compressed by the drum.

Over time, if the pattern is worn from repeated embossing of the wood, the drum may be replaced. In some embodiments, the drum may have replaceable plates so that the pattern can be replaced when worn, or so the pattern being embossed can be switched to an alternative pattern. The plates may be flexible and bent around the drum when applied, or formed into a semicircle shape and applied into two halves around the drum.

The height of the drum above the surface, or the distance between the drums if there are two drums, may be adjustable to control the amount of pressure applied by the drum against the wood. In an embodiment, if the wood is 25.4 mm, the drum may be adjusted to 25.2 mm.

Applied in this way, the Paulownia wood pieces have embossed patterns with a depth of about 0.5 mm between high and low points of the embossed pattern. As described above, the embossed pattern may simulate a wood grain pattern.

In addition, the drum may be heated such that the embossing surface of the drum is at an elevated temperature when it is pressed against the wood. For example, the drum may be electrically heated, such using heating wire wound into the drum to provide a uniform heat. The heating wire may be 2080 Cr20Ni80 Nichrome wire. Alternative heating sources may be used, such as elevating the ambient temperature in the facility where the embossing takes place, or heating the drum with other means such as steam or hot water. Preferably, the surface temperature of the drum is 120 C to 135 C.

Paulownia wood is particularly suited for embossing because the wood is soft enough to be heavily embossed. The fibres are also strong enough to not break under the pressure of the embossing so that the surface of the embossed wood is preserved without ruptures. Ruptures in the surface of the wood may cause splinters when handled, moisture points, increase the susceptibility to rot and more rapid deterioration, and detract from the visible appearance.

Elevating the temperature of the embossing drum also assists with reducing the breaking fibres of the wood and making the wood more pliable under pressure.

Preferably, the Paulownia wood is kiln dried to about 8 to 12% moisture level prior to embossing. The reduced moisture level is preferred as it makes the wood lighter, easier to transport and less likely to warp during transport, storage, or once installed.

The embossed wood may be treated, such as with primer and/or other surface treatments. For example, primers may be applied to protect from UV and are oil and latex based. One or more coats of polyurethane (PU) sealer may be used to coat the wood products, such as PU Clear Sealer from Sherwin-Williams™.

The primer may be a solid colour to make the application of a final colour easier. For example, a grey primer may be used so that the wood can painted a final colour, such as white, dark colours or any other colour.

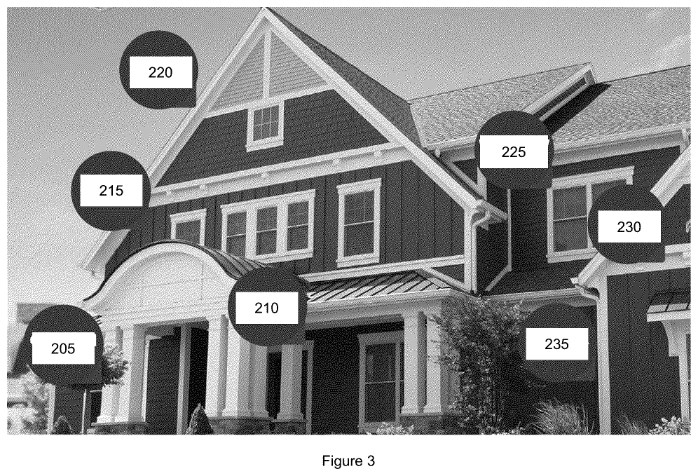

The embossed wood pieces may be used for a variety of purposes. For example, in a preferred use, the embossed wood pieces may be used as trim on houses such that the embossed surface is visible. For example, the embossed wood may be used as window trim and the visible grain on the embossed wood may distinguish the trim from the remainder of the window. With reference to FIG. 3, the embossed wood may be used as column trim 205, door trim 210, batten 215, fascia 220, window trim 225, band board 230, and corner trim 235.

If the embossed wood pieces are embossed on a single surface then the wood pieces may be useable with the textured/embossed surface visible or the reverse/smooth surface visible. As mentioned above, the embossed wood surface may be embossed with a simulated wood grain surface. In this way, the embossed wood pieces may be useable in more locations or positions, either for a wood grain finish or a smooth finish. In addition, if a single surface of the wood piece is embossed, the reverse/smooth surface may abut more tightly with other portions of the structure, reducing potential air drafts or entrances for pests.

If the pattern embossed on the wood pieces includes in part an identifier, such as an alphanumeric code, barcode, the pattern may be used to confirm the authenticity of the wood piece when installed. The identifier may identify the supplier or source of the wood or that that the wood is being grown in particular conditions, such as in a sustainable manner. The identifier may only be a portion of the pattern. For example, a wood grain pattern may be interrupted in a portion of the grain pattern to include an identifier pattern.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

1. A method for embossing Paulownia wood using an embossing machine comprising:
forming the Paulownia wood into a wood piece having a first flat surface and an opposite flat surface parallel to the first flat surface;
passing the wood piece past a first embossing drum that applies a first pattern embedded in the cylindrical surface of the drum into the wood piece by the drum applying pressure against the first flat surface of the wood piece.

2. The method of claim 1 wherein the pattern is a simulated wood pattern.

3. The method of claim 1 wherein the pattern comprises high points more distal from the axis of the drum, and low points more proximate to the axis of the drum and the pattern is a negative to the pattern that is embossed on the wood piece.

4. The method of claim 1 further comprising passing the wood piece past a second drum in close proximity with the first embossing drum wherein the wood is compressed between the two drums.

5. The method of claim 4 wherein the second drum applies a second pattern embedded in the cylindrical surface of the second drum into the wood piece by the second drum applying pressure against the opposite flat surface of the wood piece.

6. The method of claim 4 wherein the first embossing drum and the second embossing drum apply a substantially opposite force against the wood piece as the wood piece passes between the first and second embossing drums.

7. The method of claim 1 wherein the first pattern comprises a simulated wood grain pattern.

8. The method of claim 1 further comprising kiln drying the wood piece to a moisture content of between 8 and 12%.

9. A Paulownia wood piece comprising a first flat surface embossed with a pattern, the pattern comprising high and low portions formed by compressing the wood.

10. The wood piece of claim 9 wherein the pattern comprises a simulated wood grain pattern.

11. The wood piece of claim 9 wherein the wood piece further comprises a second flat surface, opposite the first flat surface, that is smooth.

12. The wood piece of claim 9 wherein the pattern comprises a identifier.
